(19) United States
(12) Patent Application Publication
(10) Pub. No.: US 2008/0211145 A1
(43) Pub. Date: Sep. 4, 2008

(54) Composite Component Production Using Fluid Density and Pressure

(75) Inventor: Neil Deryck Bray Graham, West Australia (AU)

Correspondence Address: BAKER & DANIELS LLP;111 E. WAYNE STREET, SUITE 800, FORT WAYNE, IN, 46802, US

(73) Assignee: QUICKSTEP TECHNOLOGIES PTY LTD, Canning Vale (AU)

(21) Appl. No.: 11/994,062

(22) PCT Filed: Jul. 5, 2006
(86) PCT No.: PCT/AU06/00945

§ 371 Date: Apr. 17, 2008

(30) Foreign Application Priority Data
Jul. 5, 2005 (AU) 2005903569

(51) Int. Cl. B29C 43/10

(52) U.S. Cl. 264/570; 425/405.1

(57) ABSTRACT

A production system for producing a composite component including, a mould assembly (1) including a relatively rigid mould section (3), an elastically deformable mould section (5), fluid pressure means for applying a fluid pressure due to a density and/or pressure of a fluid (12) on said elastically deformable mould section, and a resin supply means (17) for supplying resin (23) to a mould chamber (8) defined between the mould sections when brought together.

The present invention is directed to the production of composite components made of fibre reinforced composite material, and is in particular directed to the production of composite components using fluid density and pressure, and preferably also fluid temperature. The present invention will be described with respect to its use in the production of boat hulls. It is however to be appreciated that the present invention is not limited to this application and that other applications are also envisaged.

It is now normal practice to use fibre reinforced composite material to produce large boat hulls because of its relative strength and lightness in weight. Commonly used methods to lay down the boat hull include spray lay-up and hand lay-up methods. The spray lay-up method uses a spray consisting of chopped reinforcing fibre and catalysed resin which is applied to the surface of a mould. In the hand lay-up method, the fibre in the form of woven, knitted, stitched or bonded fabric is laid on the surface of the mould and resin is then subsequently impregnated into the fibre lay-up using hand operated rollers and brushes. In both methods, the resin is left to cure under standard atmospheric conditions.

As the resin is exposed to the atmosphere in the above described two methods, significant amounts of volatiles, and in particular styrene gas, is emitted from the resin, and the airborne volatile concentrations can be high enough to reach levels hazardous to health. As government health authorities introduce legislation to control such emissions, boat builders need to move to other methods which minimise such emissions.

One such method is known as vacuum bagging where a release film, breather film and finally a vacuum bagging film is located over a composite lay-up applied using the above-described hand lay-up method. The vacuum bagging film is then sealed along its edge and the air from under the film evacuated using a vacuum pump. This vacuum bagging method helps to better consolidate the composite lay-up and ensure better wetting of the fibre as well as helping to reduce the amount of volatiles emitted during curing.

In a further development of this vacuum bagging method, the vacuum bagging film is laid out over a dry composite lay-up, and catalysed resin drawn into the lay-up using an infusion method while the air under the vacuum bag film is evacuated by the vacuum pump. A knitted non-structural fabric or resin distribution tubes can be laid over the composite lay-up to assist in resin distribution under the vacuum bagging skin through the lay-up. Such a method is for example described in U.S. Pat. Nos. 4,902,215 and 5,052,906.

While these vacuum bag based methods do help to reduce airborne volatile emissions, they are time consuming methods as great care must be taken to apply the films and ensure that there are no air leaks through the vacuum bagging film. If insufficient care is taken to ensure that there are no air leaks and if the resin is not properly mixed, this could lead to incomplete infusion of resin, with areas of the lay-up being left un-wetted with resin. The resultant dry areas will render the boat hull unusable. Furthermore, the costs can be high because the vacuum bagging film as well as the release and breather films used in this method can usually only be used once and must subsequently be disposed of. Any other resin distribution components such as resin distribution lines will also need to be discarded.

All of the above methods are nevertheless only suited for one off or small scale production of boat hulls and are not suitable for the mass production of such hulls. Another composite production method, which has been used in particular for the production of high precision composite components for the aeronautical and automotive industries, is resin transfer moulding (RTM). This production method requires the use of solid male and female mould dies, which when held together define a mould cavity. Reinforcing fibre and other material is carefully laid within the mould cavity, and resin is injected under high pressure into that cavity.

There are a number of problems associated with the use of RTM in the production of boat hulls.

a) It is necessary to manufacture expensive matched male and female mould dies having high dimensional tolerances.

b) The exothermic reactions during the curing of the catalysed resin leads to substantial temperature increases within the composite lay-up. It can be difficult to control such temperature increases when matched mould dies are being used.

c) In RTM, it is common practice to use a fibre reinforcing laminate pre-form having a central foam core to facilitate infusion of the resin therethrough. If the reinforcing laminate is laid incorrectly with the mould cavity, they can act to block and impede the resin flow through the cavity resulting in areas that remain poorly or not wetted by resin. Care must therefore be taken to properly lay the reinforcing fibre resulting in long production times.

d) Upright fittings such as the bulkheads and web reinforcements must be fixed to the hull shell after the hull shell has been cured. As well as extending the total production time, the join area between the hull and bulkheads will inherently form an area of weakness within the hull because of the discontinuity in material properties along the join line between the hull shell and bulkheads.

In U.S. Pat. No. 5,971,742, an apparatus is described which replaces each of the solid mould dies with a rigid housing supporting a thin, semi-rigid fibreglass membrane providing the mould surface. The housing and membrane together define a fluid chamber filled with a non-compressible heat conductive fluid. Temperature control coils extend into each fluid chamber to control the temperature of the fluid within the chamber. While this arrangement helps to alleviate the first problem, the high temperatures generated by the curing resin still requires a cooling period for the production plant after each production sequence. Furthermore, the use of semi-rigid mould walls having minimal deflection will still leave the possibility of the fibre preform being trapped at points between the opposing mould walls leading to point contacts where resin is unable to flow through. The practical problems associated with trying to form integral upright fittings, with the difficulty in transferring resin into upright portions of a fibre preform still also remain.

Any discussion of documents, systems, acts or knowledge in this specification is included to explain the context of the invention. It is not to be taken as an admission that any of the material formed part of the prior art base or the common general knowledge in the relevant art in or any country on or before the priority dae of the claims therein.

It is therefore an object of the present invention to provide a composite component production method that avoids at least one of the disadvantages of prior art production methods including the RTM production method described above.

With this in mind, according to one aspect of the present invention there is provided a method of producing a composite component using a mould assembly having a relatively rigid mould section, and an elastically deformable mould section, the method including:

bringing together the rigid mould section and elastically deformable mould section, with fibre reinforcing material located within a mould chamber defined between said mould sections;

applying a fluid pressure due to a density and/or pressure of a fluid at least to said elastically deformable mould section; and

supplying resin into the mould chamber to thereby wet the reinforcing material located therebetween.

The relatively rigid mould section may be a female mould section having female mould cavity. The elastically deformable mould section may be a male mould face. It is however envisaged that the relatively rigid mould section, while the elastically deformable mould section may be the female mould section.

The elastically deformable mould section can readily conform to the variation in thickness of the fibre reinforcing material which may be provided using overlapping layers of sheets of this material. This avoids the problem of pinch zones associated with RTM where an excess thickness of fibre reinforcing material in particular areas when the matched dies are held together can lead to the impeding of resin flow into these areas.

The relatively rigid mould section may be a female mould section with a female mould cavity, and the elastically deformable mould section may be a male mould section with a male mould face; the method including:

laying fibre reinforcing material within the female mould cavity;

bringing together the male mould section and the female mould section so that the fibre reinforcing material is located in a mould chamber defined between said female mould cavity and male mould face, with the male mould section having an outer surface providing the male mould face, and an inner volume for accommodating a fluid;

filling at least the inner volume of the male mould section with fluid so that a fluid column pressure is applied by the fluid to an inner surface of the male mould section such that the male mould face generally conforms with the reinforcing material located within the mould chamber; and

supplying resin through a resin supply means into the mould chamber to thereby wet the reinforcing material located therein.

The term “fibre reinforcing material” is used herein to refer to dry reinforcing fibre bundles formed of pre-cut fibre material and woven layers of this material, or laminates incorporating foam or other cores and reinforcing fibre fabric that have not been pre-impregnated with resin.

The fluid within the inner volume applies a fluid column pressure over an inner surface of the inner volume of the male mould section. As the male mould section is formed of an elastically deformable material, the fluid column pressure applied to the male mould section acts to conform and deform the male mould face to the shape of the fibre reinforcing material laid over the underlying female mould cavity. Furthermore, fluid column pressure applied by the fluid interacts with the fluid column pressure applied by the resin that has been supplied to the mould chamber. In particular, the fluid column pressure will naturally seek to come into equilibrium with the column pressure of the resin within the mould chamber so that the applied pressures are balanced. This has the effect of ensuring that the resin is uniformly distributed within the mould chamber and completely wets the fibre reinforcing material.

The fluid density of the fluid used to fill the inner volume may be selected to be close in value to the fluid density of the resin being supplied to the mould chamber. This allows the resin to be distributed as a result of the “balanced density” effect between the liquid within the bladder and the resin drawn into the mould chamber between the female mould cavity and the male mould face. The principle of the balanced density is described in the Applicant's International Patent Application No. PCT/AU02/00078, details of which are incorporated herein, by reference. This balanced density effect occurs as the fluid pressures on either side of an elastically deformable membrane seek to balance out so that the resin can be evenly distributed even in the situation where the mould cavity is inclined at an angle.

It is noted that the resin will typically have a higher density than water, which may typically be used to fill the inner volume. The density of the resin and water may however be adjusted by preheating the water to thereby heat and lower the density of the resin. In addition, the resin may be preheated for this purpose. It is also possible to use a fluid of higher density than water within the inner volume. High temperature capacity fluids such as glycol can alternatively be used. Another alternative to ensuring that there are balanced pressures on opposing sides of the male mould section is to increase the height of the fluid above the male mould section thereby increasing the fluid column pressure over the inner surface of the male mould section.

As the male mould section is formed of an elastically deformable material, preferably with some point reinforcing, the male mould face will be deformed in shape due to the interaction between the fluid and the resin to thereby urge the resin into the composite material as well as helping to distribute the resin through the lay-up into corners and other “difficult” areas. The use of an elastically deformable material for the male mould face together with balanced density and/or pressure plus vacuum also allows more complicated structures to be made. This includes producing boat hull shells with the bulkheads and stringers and any other web integrally moulded with the hull shell. Furthermore, less precision is required to lay the reinforcing fibre material as the distribution of the resin is not limited by the tight tolerances of the flow paths in conventional RTM methods.

While the resin can be distributed purely as a result of the interaction of the fluid and resin pressures, the infusion of resin into the composite material may be facilitated by applying a vacuum within the mould chamber. To this end, the method according to the present invention may also include supply resin into the mould chamber while applying a vacuum to the mould chamber. The vacuum will assist in the removal of trapped air within the composite material as well as assisting to draw the resin into the mould chamber thereby wetting the composite material with the resin.

The fluid and resin pressures may be individually varied or may be varied relative to each other in a predetermined relationship. For example, the resin pressure may be initially high to flood the mould chamber with a relatively large volume of resin. This resin volume can be accommodated by the outward movement of the resiliently deformable mould section away from the fibre composite material. The fluid pressure may then be subsequently increased to distribute and drive out the excess resin as the resiliently deformable mould section is pressured back against the composite fibre material. This may lead to more rapid wetting of the fibre reinforcing material. It is also envisaged that the resin pressure and/or the fluid pressure may be pulsed to facilitate distribution of the resin.

In the case of high viscosity resin, the mould assembly and mould chamber may be heated. This facilitates wetting of the fibre reinforcing material because the heating of this resin helps to reduce its viscosity while being distributed through the mould chamber.

The method may also include applying balanced fluid pressures on opposing sides of the mould assembly. One of the advantages of this is that it leads to more uniform pressure across the composite component being produced leading to more uniform material characteristics through the finished component. A production system allowing this balanced pressure to be applied will be subsequently described.

According to another aspect of the present invention, there is provided a production system for producing a composite component including, a mould assembly including a relatively rigid mould section, an elastically deformable mould section, fluid pressure means for applying a fluid pressure due to density and/or pressure of a fluid on said elastically deformable mould section, and a resin supply means for supplying resin to a mould chamber defined between the mould sections when brought together.

The relatively rigid mould section may be provided by either a female mould section having a female mould cavity, or a male mould section having a male mould face. The elastically deformable mould section may be correspondingly provided by either said male mould section or said female mould section.

The resin supply means may be provided by at least one resin supply line in fluid communication with the mould chamber. The resin supply line may communicate with an opening in the male mould face or female mould cavity or may enter an opening provided between the outer periphery of the female and male mould sections.

At least one vacuum line may also be in fluid communication with the mould chamber when a vacuum is being used to evacuate the mould chamber of air. To this end, a sealing means may be provided between the female and male mould sections for providing an at least substantially air tight seal for the mould chamber. The vacuum line may communicate with an opening in the male mould face or the female mould cavity or may enter an opening provided between the outer periphery of the female and male mould sections.

The male mould section may be at least substantially made from rubber or other similarly elastic and deformable material. Preferably, the male mould section may be made of a material and or alternatively may have a surface of the male mould face which readily separates from the composite component when fully cured. This eliminates the need for any release film flow membrane, breather etc. to be provided within the mould chamber.

The surface of the male mould face adjacent the fibre composite material may be provided with a series of channels extending along its surface. Preferably these channels may extend in a mesh pattern across the entire surface of the male mould face. These channels provide a passage through which resin and air can pass to facilitate the evacuation of air and distribution of the resin through the fibre composite material. The male mould face may be of a sufficient deformability such that the channels will flatten when a high enough fluid pressure is applied to the opposing side of the male mould face. This facilitates the driving out of the resin into the fibre composite material.

According to a further aspect of the present invention, there is provided a production system for producing a composite component including:

a mould assembly including:

a relatively rigid female mould section having a female mould cavity;

a peripheral portion surrounding the periphery of the female mould cavity, the ring portion including a ring chamber within which a resin can be supplied, resin supply means for supplying resin to the ring chamber;

a male mould section formed of an elastically deformable material, the male mould section having an outer male mould face, and an inner volume for accommodating a liquid;

a mould chamber being defined between the female mould cavity and the male mould face when the female and male mould sections are brought together; and

a vacuum supply means for producing a vacuum in the mould chamber.

The ring chamber may be defined by a peripheral relatively rigid ring flange surrounding and supporting the male mould section, the ring flange engaging the peripheral portion surrounding the female mould cavity. A seal means, for example a resilient sealing rib(s), may be provided between the ring flange and the ring portion to provide an at least substantially air tight seal for the ring chamber.

The pool of resin within the ring chamber serves two purposes. It firstly provides the source of resin for wetting the reinforcing material within the mould chamber. It also provides a liquid seal around the mould cavity that ensures that a vacuum can be applied to that mould chamber.

At least a peripheral portion of the reinforcing material may extend into the area of the ring chamber, and may act as a wick to allow the resin to permeate into the rest of the reinforcing material through capillary action.

A series of resin supply lines may supply resin to the ring chamber at points distributed along the ring chamber. Alternatively, a single resin supply line may extend parallel with the ring chamber, the supply line having a series of bleed lines spaced therealong from which resin can be discharged into the ring chamber.

The vacuum supply means may include a vacuum pump and at least one vacuum line. A first vacuum line may be in communication with the mould chamber. The first vacuum line may be connected to an opening provided within the male mould section to thereby apply a vacuum to the mould chamber. Preferably a second vacuum line is provided in communication with the ring chamber to thereby apply a vacuum to the ring chamber. A valve may control the vacuum being applied by both the first and second vacuum lines. In a first position of the valve, a vacuum may be applied by both vacuum lines such that there is little to no pressure differential across the resin accumulated within the ring chamber. This restricts the transfer of resin from the ring chamber into the mould chamber. In a second position, the first vacuum line is blocked/closed to stop the vacuum in the ring chamber then opened to the atmosphere so that only a vacuum is applied by the second vacuum line. This results in a sudden increase in the pressure differential across the resin held in the ring chamber thereby forcing a “wave” of the resin through into the mould chamber. The vacuum is again reapplied to the ring chamber by again opening the first vacuum line when the resin is almost exhausted from the ring chamber. This allows more resin to be supplied to the ring chamber. The apparatus thereby allows for periodic waves of resin to enter the mould chamber.

A pulse of high pressure gas may also or alternatively be periodically supplied to the ring chamber from a pressurised gas supply. The effect of this high pressure pulse is to force the resin within the ring chamber into the mould chamber with a “wave” of resin being thereby transferred into the mould chamber. This resin wave helps to more rapidly and more efficiently transfer and infuse the resin into the composite material to ensure complete wetting therethrough. A resin sensor may be respectively provided at a lower and higher portion of the ring chamber to check when the resin level therein has reached a low point beyond which the resin seal would be broken, and a high point where no further resin is required to be supplied. When the resin reaches that lower point, the pressure differential and/or any further high pressure gas supply the ring chamber is stopped and further resin can then be delivered to replenish the supply within the ring chamber.

Vibration means such as a surface mounted external mechanical vibrator may also be used to vibrate the mould assembly and ensure complete wetting of the composite material.

In the Applicant's U.S. Pat. No. 6,149,844 there is described an apparatus for producing composite components utilising balanced pressure. The apparatus has two opposing pressure chambers, one chamber supporting a floating rigid mould, the other chamber having an elastically deformable mould face. A composite lay-up could be laid on the mould, and a vacuum bag is then located over the lay-up and evacuated to thereby compact the lay-up and withdraw most of the air from the lay-up. The pressure chambers are then brought together so that the resiliently deformable mould face would be located over the vacuum bag under which is located the composite lay-up. Fluid at elevated pressure and temperature is then circulated through each pressure chamber to ensure that a balanced pressure and a uniform temperature is applied to the composite lay-up. This leads to composite components being produced having higher material quality than would be the case with more conventional methods including RTM.

Balanced pressures may also be used according to the present invention. To this end, the female mould section may be supported in a floating arrangement on a first housing to form a first pressure chamber while the male mould section may be supported on a second housing to form a second pressure chamber. The apparatus according to the present invention does not require the use of a separate vacuum bag to evacuate the composite fibre material, and the male mould/skin section may directly contact the composite fibre material. Fluid circulation means may circulate fluid at elevated pressure through each pressure chamber during the production process. The fluid pressure may be substantially equal in both chambers to thereby provide the additional benefits of balanced pressure.

It is also envisaged that the fluid being circulated through each pressure chamber is also at an elevated temperature where high temperature curing resins are being used or where the resin needs to be heated to reduce its overall viscosity and therefore its fluid density. Fluid at a lower temperature can be subsequently circulated through the pressure chambers to facilitate cooling of the component as the resin cures.

The present invention has particular advantages over the prior art RTM production methods currently used to produce boat hulls. Firstly, it is not necessary to produce expensive and heavy mould dies. Indeed, the female mould section can be fabricated from relatively low cost material as it is not required to support any substantial pressure or weight. The bladder construction of the male mould section can be simply formed from resiliently deformable material such as rubber, for example natural latex rubber. As well as being relatively simple to form, the weight of the male mould section will be much lower than would be the case for a rigid mould die.

Furthermore, balanced pressure and vacuum is a far more effective means of distributing the resin evenly within the reinforcing fibre material. Because of this efficiency, the mould chamber can be more complex in shape and may for example include volumes for forming the bulkheads of the ship hull. Also, separate components such as connecting lugs can be located within and integrally embedded within the final composite component. This allows the boat hull to be constructed as a single integral unit leading to more uniform material properties through the boat hull with no areas of potential weakness. Also, as the various components of the boat hull can be formed at the same time, this leads to significant reductions in production times. Furthermore, by comparison to conventional RTM methods where special high flow resins and high quality fibre materials are required, the present invention can use a variety of different resins and fibre materials.

### DETAILED DESCRIPTION OF THE INVENTION

It will be convenient to further describe the invention with reference to the accompanying drawings which illustrate preferred embodiments of the present invention. Other arrangements are possible, and consequently, the particularity of the accompanying drawings is not to be understood as superseding the generality of the preceding description of the invention.

In the drawings:

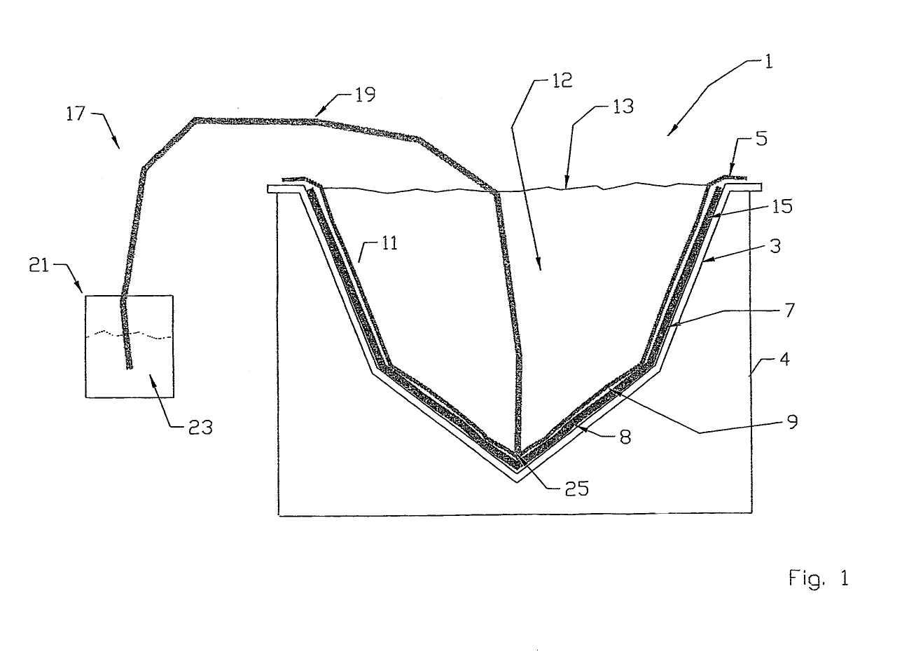

FIG. 1 is a schematic cross-sectional view showing a first preferred embodiment of a production system for producing a composite component according to the present invention;

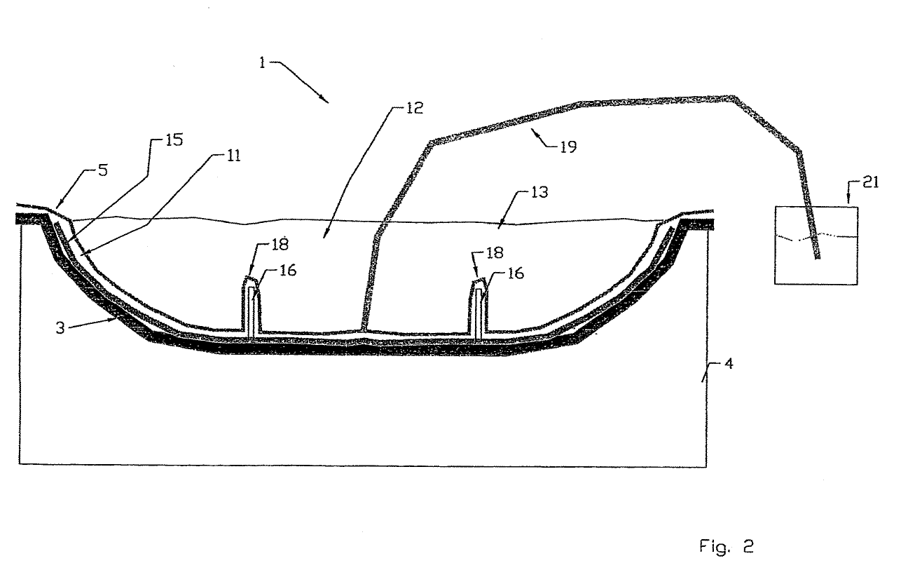

FIG. 2 is a schematic side cross-sectional view of the production system of FIG. 1;

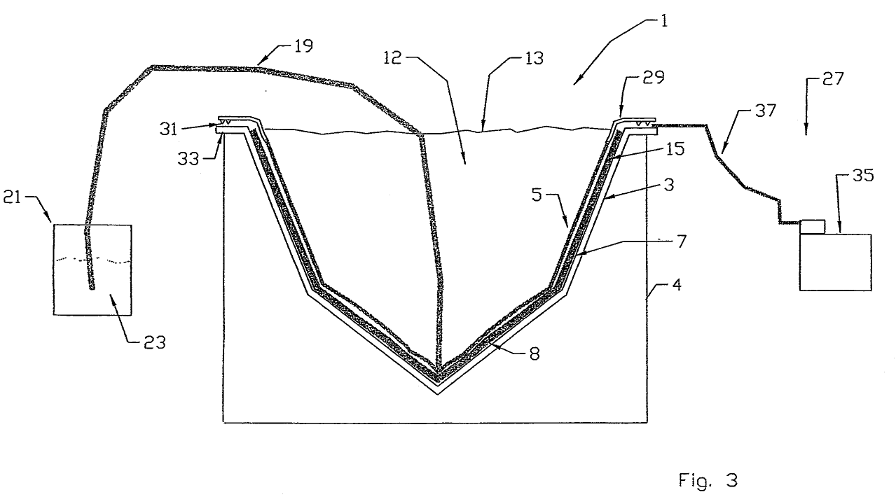

FIG. 3 is a schematic cross-sectional view of a second preferred embodiment of a production system according to the present invention;

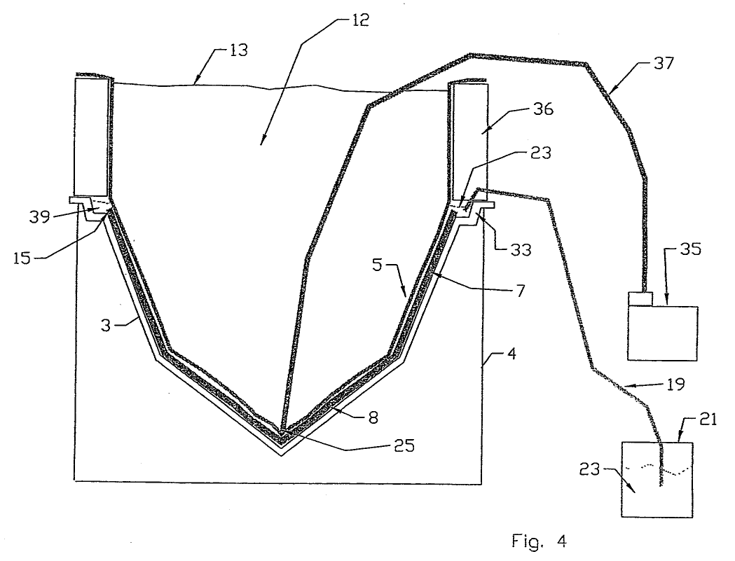

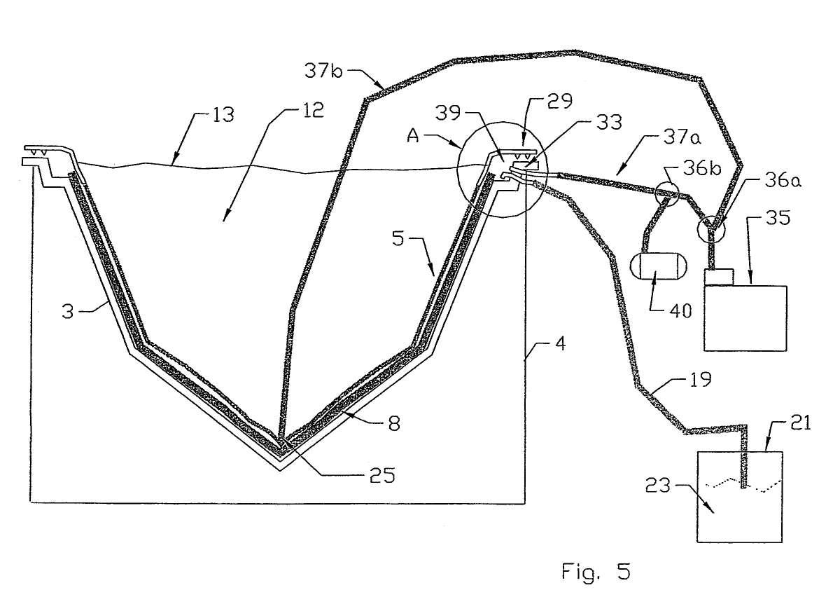

FIG. 4 is a schematic cross-sectional view of a third preferred embodiment of a production system according to the present invention;

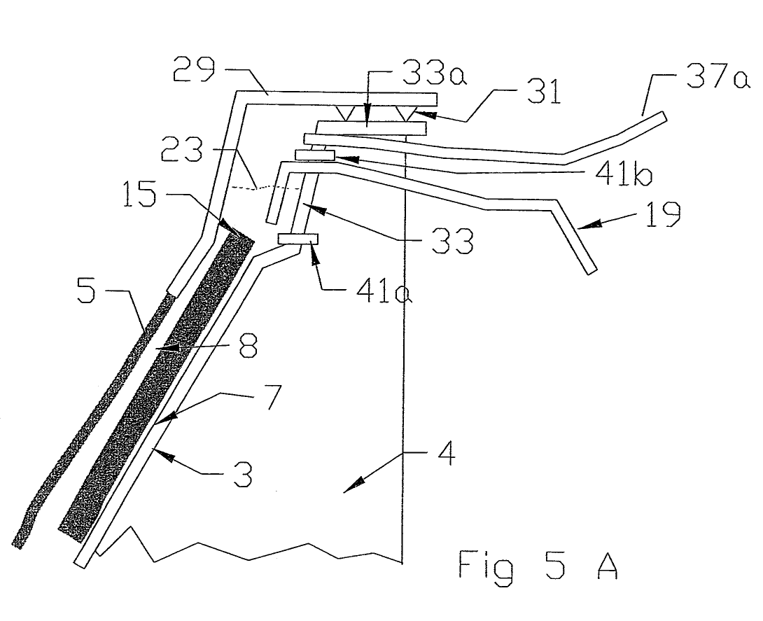

FIG. 5 is a schematic cross-sectional view of a fourth preferred embodiment of a production system according to the present invention;

FIG. 5A is a detailed view of section A of FIG. 5;

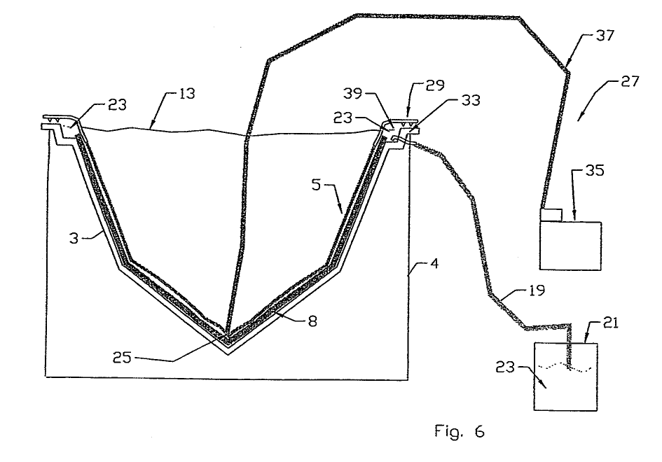

FIG. 6 is a schematic cross-sectional view of a fifth preferred embodiment of a production system according to the present invention; and

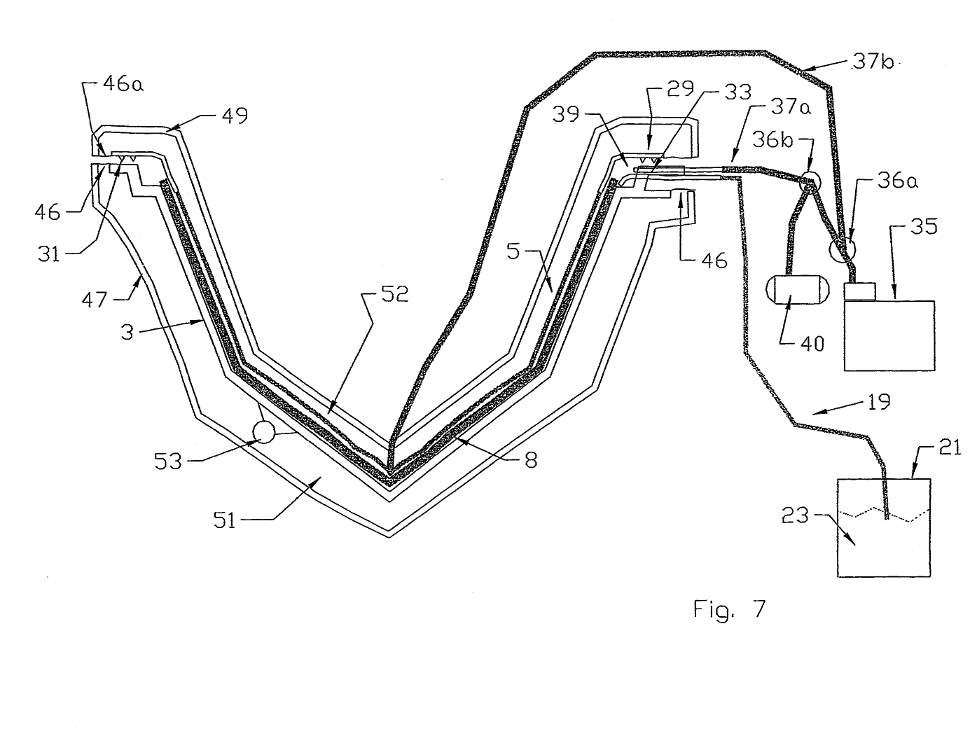

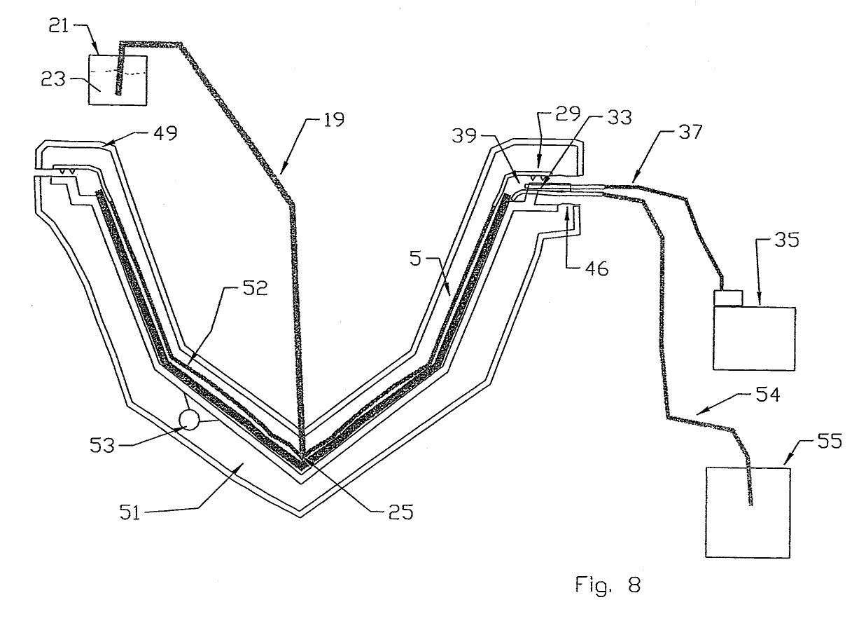

FIG. 7 is a schematic cross-sectional view of a sixth preferred embodiment according to the present invention.

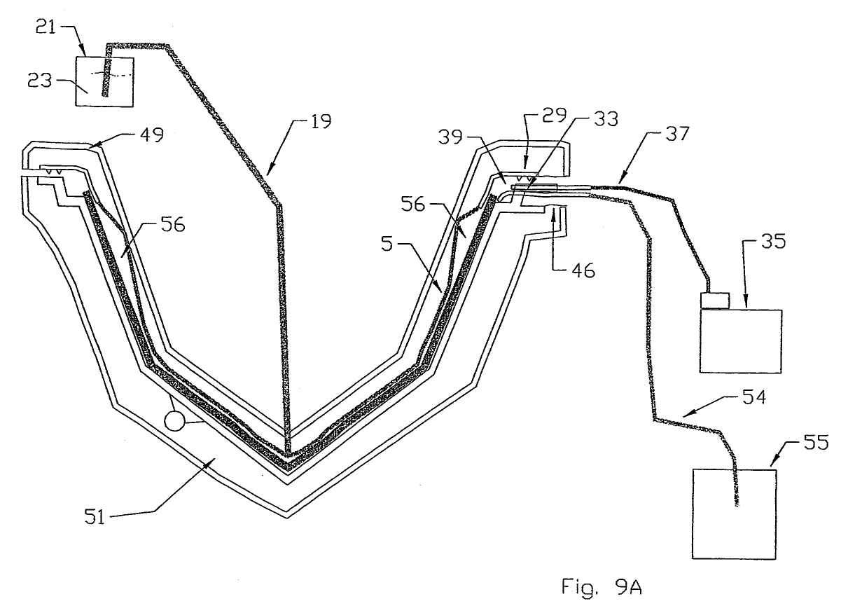

FIG. 8 is a schematic cross-sectional view of a seventh preferred embodiment according to the present invention;

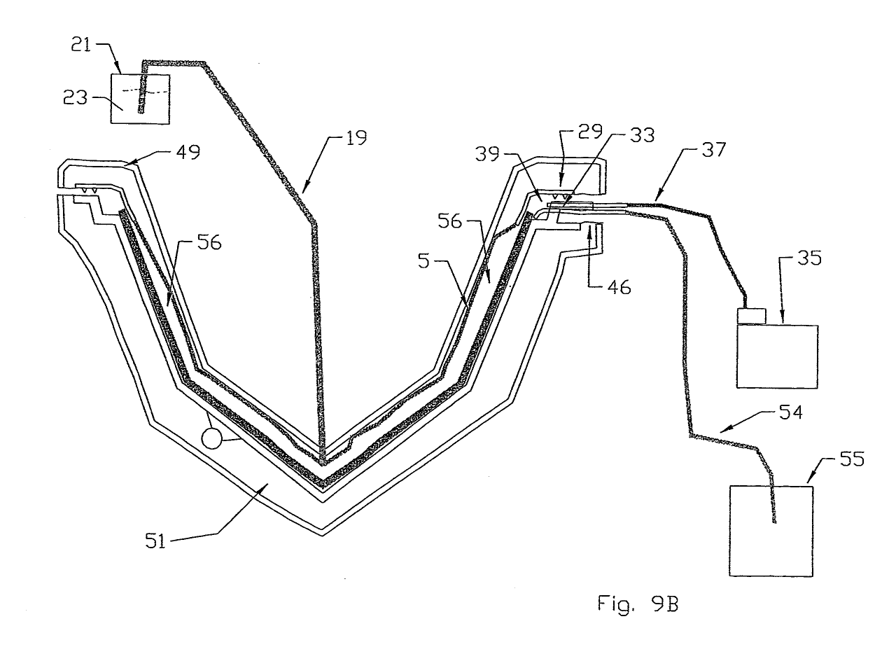

FIGS. 9A and 9B shows schematically the separation of the male mould section from the completed component within the embodiment of the present invention shown in FIG. 8; and

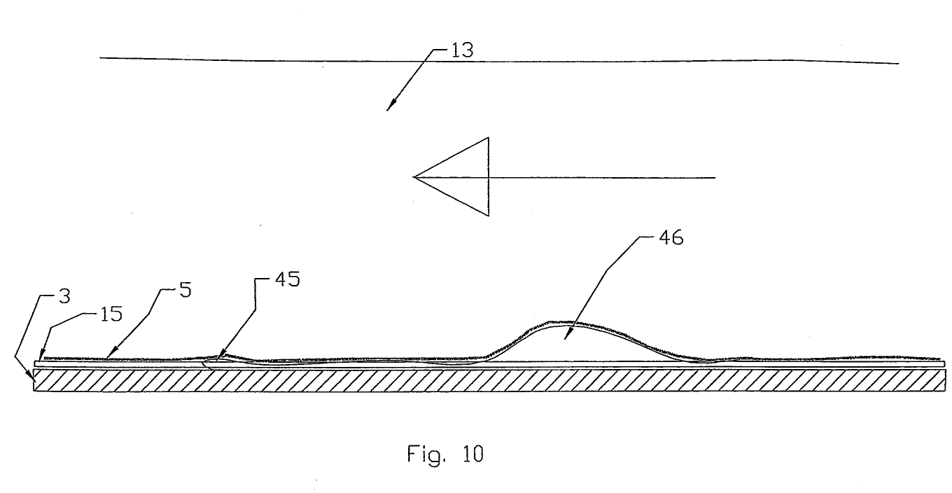

FIG. 10 is a detailed schematic view showing a resin wave according to the present invention;

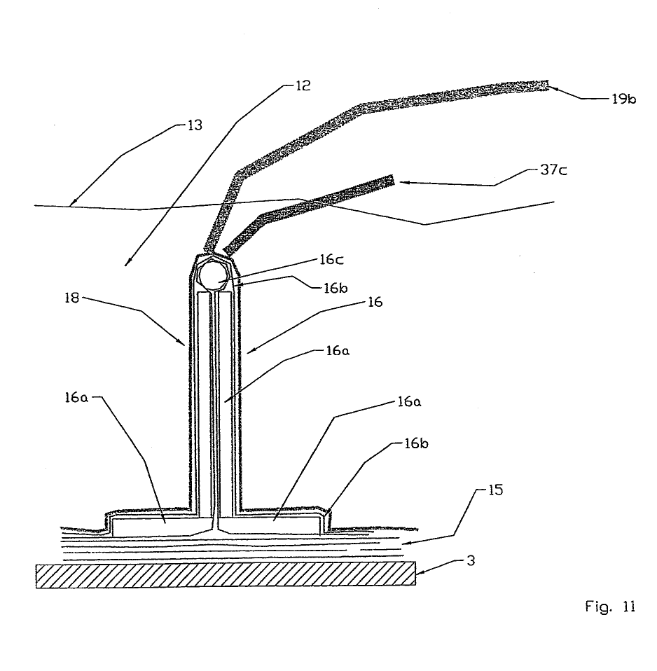

FIG. 11 is a detailed schematic view showing a reinforced upright being formed according to the present invention and;

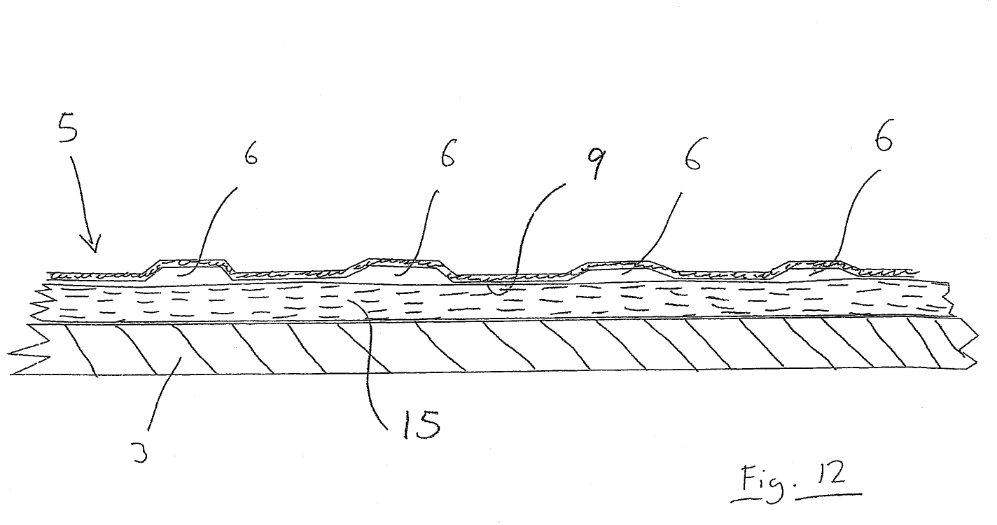

FIG. 12 is a detailed schematic view of an embodiment of the male mould section according to the present invention.

We initially note that corresponding features in different preferred embodiments of the present invention are generally provided with the same reference numeral for clarity reasons.

Referring initially to FIG. 1, there is shown a basic configuration of a production system, a mould assembly 1 having a female mould section 3 and a male mould section 5. The female mould section 3 includes a female mould cavity 7 and is made of a relatively rigid material. The female mould section 3 is rigidly held in position on a mould support arrangement 4. The male mould section 5 is formed of an elastically deformable material such as rubber and includes an outer surface 9 providing the male mould face for the male mould section 5. The male mould section 5 furthermore includes an inner volume 11 for accommodating a liquid 13 during the production process.

According to the method of the present invention, fibre reinforcing material 15 is initially laid within the female mould cavity 7. The male mould section 5 is then located over the female mould section 3 and the inner volume 11 of the male mould section 5 is then filled with a fluid 12. This fluid 12 can conveniently be water, but the use of other fluids of higher density or higher temperature capacity such as glycol is also envisaged. A resin supply means 17 including a resin supply line 19 and a resin tank 21 then supplies catalysed and/or mixed liquid resin through the resin supply line 19 to an opening 25 provided in the lowermost point of the male mould face 9. The resin 23 is supplied to the mould chamber 8 defined by the narrow volume between the female mould face 7 and the male mould face 9. The resin 23 may be pumped from the resin tank 21 to the mould chamber 8, or the resin tank 21 can be held at a height above the level of the fluid 13 within the inner volume 11 to allow resin 23 to flow into the mould chamber 8. The pressure within the mould chamber 8 at the opening 25 is a function of the fluid column height above the lowermost point of the male mould section 5.

The resin 23 upon entering through the opening 25 is dispersed through the fibre material 15 because of the pressure differential at this point and the capillary attraction of the resin to the reinforcing fibre material 15 with the resin “wicking” along the fibres. As the resin 23 continues to flow into the mould chamber 8 and spreads and moves towards the sides and top of the fibre bundle 15, the fluid column pressure on the male mould section 5 will also progressively decrease to a minimum adjacent the fluid level 13. As this can slow the speed of progress of the resin 23 as it moves higher within the mould the fluid 12 can preferably have a higher density than the resin 23, or the fluid level 13 may be at a height significantly above the mould sections 3, 5 such that a sufficient fluid column pressure is applied over the male mould section 5 to disperse the resin 23 through the fibre bundle 15. It is also envisaged that either the resin 23 or the fluid 12 be preheated to thereby result in the lowering of the viscosity and therefore the density of the resin 23 to more easily infuse the part over a long period of time say 40 C. The resin selected can be catalysed and/or mixed to only cure at a high temperature say 60 to 80 C. Therefore to cure the part the fluid temperature can then be increased rapidly to 80 C to cure the part.

The supplied resin 23 is thereby distributed over and infused into the fibre composite material or fibre bundle 15 as the pressure applied by the fluid 13 accommodated within the inner volume 11 interacts with and seeks to balance forces with the liquid catalysed resin 23 within the mould chamber 8. This helps ensure that the resin 23 is distributed evenly through the composite bundle 15.

The mould assembly 1 including the female mould section and the male mould section 5 can also be heated prior to and during the production process. This allows the use of high viscosity resin 23 which needs to be heated to reduce its viscosity thereby facilitating the wetting of the fibre reinforcing material 15.

The male mould section 5 must be deformable to enable the fluid column pressures to act on the resin 23 as well as to ensure that the male mould face conforms to the fibre bundle 15 supported within the female mould cavity 7. Referring now to FIG. 2, the deformability of the male mould section 5 together with the force applied by the fluid 12 accommodated within the inner volume 11 thereby allows components of more complicated shapes to be produced. FIG. 2 shows the fibre composite material 15 laid to further include uprights 16. These upright sections eventually provide the uprights required for reinforcement of the finished boat hull, these uprights being integrally formed with the rest of the hull. The male mould section 5 can be shaped to include the channels 18 for allowing these uprights to be integrally formed with the rest of the boat hull. The resin 23 is urged up through the channels 18 which conform around the uprights 16 due to the fluid column pressure applied to the outer surface of the channels 18.

To facilitate the infusion of resin 23 through the composite material 15, a vacuum can be provided within the mould chamber 8 to evacuate air from the fibre reinforcing material 15 as well as to draw the resin 23 into the mould chamber 8. FIG. 3 shows a production system similar to that shown in FIG. 1, but further including vacuum supply means 27. The male mould section 5 further includes a relatively rigid ring flange 29 surrounding and supporting the resiliently deformable portion of the male mould section 5. A seal means, for example resilient sealing ribs 31, is provided between the ring flange 29 and the peripheral portion 33 of the female mould section surrounding the female mould cavity 7. This allows a vacuum to be provided within the mould chamber 8. The vacuum supply means includes a vacuum pump 35 and a vacuum line 37 in communication with the mould chamber 8. The vacuum line 37 is shown in FIG. 3 as communicating through an opening (not shown) provided between the ring flange 29 of the male mould section and the peripheral portion 33 of the female mould section 3. It is to be appreciated that the vacuum line 37 could alternatively be connected to an opening provided in the male mould section 5 or female mould section 3, this opening being in fluid communication with the mould chamber 8.

FIG. 4 shows another example embodiment of the present invention which differs from the embodiment shown in FIG. 3 in that the vacuum line 37 is connected to the opening 23 located at the lowermost portion of the male mould section 5. A ring chamber 39 is defined by a space provided between a peripheral shoulder portion 33 provided around the female mould cavity 7 and an upper wall 36 supporting the male mould section 5. The upper wall 36 extends above the female mould section 3 such that the fluid level 13 can be at a significant height above the mould sections 3, 5 thereby ensuring that higher fluid column pressures are applied over the fibre bundle 15. The resin line 19 or a container of resin poured into the ring supplies resin 23 from the resin tank 21 to the ring chamber 39 such that a volume of resin 23 is held within the ring chamber. This resin 23 acts as a ring seal around the mould chamber 8 to thereby allow the vacuum to be applied to the mould chamber 8. This vacuum draws resin 23 into the mould chamber 8 thereby wetting fibre bundle 15, while the resin 23 within the ring chamber 39 is replenished from the resin supply line 19. Furthermore, the periphery of the fibre bundle 15 can be partly accommodated within the ring chamber 39 to thereby act as a wick for transferring the resin 23 into the fibre bundle 15. The fluid column pressure applied to the mould chamber 8 ensures that the resin 23 is distributed evenly throughout the fibre bundle 15.

FIGS. 5 and 5A show another example embodiment of the present invention similar to that shown in FIG. 4 in that it includes a ring chamber 39 through which resin 23 can be supplied to the mould chamber 8. This ring chamber 39 is however defined by a space provided between the ring flange 29 of the male mould section 5 and the peripheral portion 33 of the female mould section 3. The peripheral portion 33 includes a side wall 33b and a top wall 33a. The resin supply line 19 extends through the peripheral portion side wall 33b to communicate with the ring chamber 39. Lower and upper resin sensors 41a and 41b are also located within the side wall 33b. In the present embodiment, first and second vacuum lines 37a and 37b are respectively in communication with the ring chamber 39 and the opening 25 provided in the male mould section 5. During the production process, resin 23 fills at least a substantial portion of the ring chamber 39. Seals 31 are provided between the ring flange 29 of the male mould section 5 and the peripheral portion top wall 33a to thereby allow the vacuum supply line 37a to properly evacuate the ring chamber 39. The seals 31 are always located above the level of the resin 23 to avoid contamination by the resin 23. The second vacuum line 37b can apply a vacuum directly to the mould chamber 8, with the vacuum pump 35 being connected to each vacuum line 37a, 37b through a first valve 36a. This valve 36a allows the vacuum pump 35 to be connected to both vacuum lines simultaneously or to only one vacuum line. When both vacuum lines 37a and 37b are connected to the vacuum pump 35, there is a minimal pressure differential between the ring chamber 39 and the mould chamber 8. Therefore, the resin 23 held within the ring chamber 39 will tend to remain and accumulate within that ring chamber. The first vacuum line 37a in communication with the ring chamber 39 can be closed off and vented to atmosphere while the second vacuum line 37b remains connected to the vacuum pump 35 thereby releasing the vacuum within the ring chamber 39. The resultant relatively sudden increase in the pressure differential across the resin ring and between the ring chamber 39 and the mould chamber 8 results in a resin wave 46 (as shown in FIG. 10) being generated which travels through the mould chamber 8 from the ring chamber 39. This resin wave produces a temporary bulge in the male mould section 5 as it travels through the mould chamber 8 and acts to push in front of the wave 46 the resin face, being the front edge of the resin 23 as it is transferred into and wets the fibre bundle 15. This resin wave effect helps to facilitate the speed of transfer of the resin 23 into the fibre bundle 15.

It may be advantageous to further assist the transfer of resin 23 from the ring chamber 39 to the mould chamber 8 by also applying periodic pulses of high pressure gas into the ring chamber 39 to assist to push the resin 23 through into the mould chamber 8. A pressure tank 40 is connected to the first resin 37a via a second valve 36b. The first valve 36a first disconnects the vacuum line from the vacuum pump 35 before the second valve 36b connects the pressure tank 40 to the vacuum line 37a. This enables a pressure pulse to be applied to the ring chamber 39 by using high pressure gas from the pressure tank 40. This pulse of high pressure gas continues until the level of resin 23 within the ring chamber 39 drops below the level of the resin sensor 41a. At that time the high pressure gas supply is stopped and the ring chamber allowed to re-fill with resin 23 until the resin reaches the level of the second resin sensor 41b. The use of high pressure gas also helps to transfer resin 23 via the resin wave 46 passing into the mould chamber 8. This further facilitates the transfer of resin 23 increasing the speed at which the composite material 15 can be completely wetted by the resin 23.

FIG. 6 shows a variation of the example embodiment shown in FIGS. 5 and 5A where the vacuum supply means 27 is now only connected through the vacuum line 37 to opening 25 within the male mould section 5. The resin 23 within the ring chamber 39 is maintained at a sufficient level to provide a seal for the mould chamber 8 to thereby allow the vacuum to be maintained therein.

FIG. 7 shows yet a further example embodiment of the present invention similar to the embodiment shown in FIGS. 5 and 5A. The difference is that the female mould section 3 is supported by the fluid in the chamber and sealed to the pressure chamber wall 47 via a resilient flange 46 in a floating relationship relative to a first outer housing 47, with a first pressure chamber 51 whereby being provided under the female mould section 3. Furthermore, the male mould section 5 is also supported by a second outer housing 49 to thereby provide a second pressure chamber 52 above the male mould section 5. The ring flange 29 supporting the male mould section 5 is connected via a resilient flange 46a to the second housing 49. Therefore both the female and male mould sections 3, 5 are sealed and supported in a floating relationship relative to their outer housings 47, 49. Liquid at elevated pressure can be circulated through both the first pressure chamber 51 and the second pressure chamber 52. The fluid pressure within each pressure chamber 51, 52 acts to force together the peripheral portion 33 of the female mould section 3 and the ring flange 29 of the male mould section 5 thereby facilitating the operation of the seal means 31. The opposing fluid pressures also acts to provide a balanced pressure over the entire extent of the composite material 15 located between the female and male mould sections 3, 5. This helps to provide a more uniform pressure over the fibre bundle 15 leading to improved compaction of and removal of air from the fibre bundle 15. Fluid at elevated temperatures can also be circulated through pressure chambers 51 and 52 to provide the necessary curing temperature where high temperature curing resins are being used. The elevated temperature also allows resin of relatively high viscosity to be used. The heating of the resin reduces its viscosity thereby facilitating the infusion of the resin through the fibre bundle.

The infusion of resin into the composite material 15 can also be facilitated by vibrating the mould assembly. A rotational vibrator 53 may therefore be secured to a portion of the mould assembly for this purpose. This vibrator 53 can for example be attached to the female mould section 3.

The example embodiment shown in FIG. 8 also utilises pressure chambers 51, 52, the primary difference with the embodiment in FIG. 7 being that the resin line 19 now supplies resin to the opening 25 with the lowermost part of the male mould section 5. A single vacuum line 37 is connected to the ring chamber 39. In this arrangement, resin is transferred from opening 25 through the mould chamber 8 towards the ring chamber 39. Any excess resin reaching the ring chamber 39 can be captured using an overflow line 54 into a resin overflow tank 55.

FIGS. 9A and 9B show the embodiment of FIG. 8 and illustrate an advantage of using a pressure chamber arrangement. It can be difficult to separate the male mould section 5 from the final cured composite component 56 because it is in direct contact with that component. Nevertheless, the male mould section can be simply peeled away from the component 56 by pumping the fluid from the pressure chamber as shown in the peeling sequence illustrated in FIGS. 9A and 9B.

As previously noted, FIG. 10 illustrates the movement of the resin wave 46 in the direction shown by the arrow and the resin face 45 travelling in front of the resin wave 46. A sequence of these resin waves 46 can be generated according to the present invention.

FIG. 11 shows in more detail an upright 16 of the type shown in FIG. 2. The upright includes a cone of foam 16a surrounded by a layer of reinforcing cloth 16b. A reinforcing rod or reinforcement materials 16c may be persistent as a reinforcement on the top edge of the upright, the rod 16c being also wrapped by reinforcing cloth 16b. The channel 18 within the male mould face 9 is conformed around the upright 16 because of the pressure of the fluid 12 surrounding the channel 18. Any air trapped within the channel 18 and the upright material 16 will tend to float upwardly as air bubbles because the air is effectively “underwater” being below the fluid level 13. A further vacuum line 37c can therefore be provided to help draw the resin into the vertical channel 18 and to remove the air escaping up through the channel 18. Once the channel is filled with resin, a further resin line 19 may then supply further resin back down the channel 18 to the rest of the fibre bundle 15. The evacuation of air from the fibre composite material 15 and the distribution of resin therein is facilitated by the provision of a series of channels 6 within the outer surface 9 of the male mould section 5 as shown in FIG. 12. These channels 6 can be provided in a mesh pattern across the at least a major portion of the outer surface 9. The channels 6 provide a passage through which air to be evacuated and resin to be distributed can pass. Increasing the fluid pressure on the male mould section results in the flattening of the channels 6 such that the entire outer surface 9 abuts the fibre composite material 15. Any excess resin retained within the fibre composite material 15 and within the channels 6 are driven out as excess resin out of the mould chamber.

1-34. (canceled)

35. A method of producing a composite component using a mould assembly having a relatively rigid mould section, and an elastically deformable mould section, the method including:
bringing together the rigid mould section and elastically deformable mould section with fibre reinforcing material located within a mould chamber defined between said mould sections;
applying a balanced fluid pressure due to a density and/or pressure of a fluid on opposing sides of the mould assembly; and
supplying resin into the mould chamber to thereby wet the reinforcing material located therebetween.

36. A method according to claim 35, wherein the relatively rigid mould section is a female mould section with a female mould cavity supported by a first pressure chamber, and the elastically deformable mould (section is a male mould section with a male mould face supported by a second pressure chamber; the method including:
laying fibre reinforcing material within the female mould cavity;
bringing together the male mould section and the female mould section so that the fibre reinforcing material is located in a mould chamber defined between said female mould cavity and male mould face;
filling the first and second pressure chambers with fluid so that a fluid pressure is applied by the fluid to an inner surface of the male mould section such that the male mould face generally conforms with the reinforcing material located within the mould chamber; and
supplying resin through a resin supply means into the mould chamber to thereby wet the reinforcing material located therein.

37. A method according to claim 36, wherein the fluid density of the fluid supplied to the first and second pressure chambers is selected to be close to the fluid density of the resin being supplied to the mould chamber.

38. A method according to claim 37, including preheating the fluid to thereby heat and lower the density of the resin.

39. A method according to claim 36, including preheating and thereby lowering the density of the resin.

40. A method according to claim 35 including supplying resin to the mould chamber while applying a vacuum to the mould chamber.

41. A method according to claim 35 including varying the pressure at which the resin is supplied.

42. A method according to claim 41 including further varying the fluid pressure.

43. A production system for producing a composite component including, a mould assembly including a relatively rigid mould section supported by a first pressure chamber, an elastically deformable mould section supported by a second pressure chamber, fluid pressure means for applying a balanced fluid pressure due to a density and/or pressure of a fluid on opposing sides of the mould assembly, and a resin supply means for supplying resin to a mould chamber defined between the mould sections when brought together.

44. A production system, according to claim 43, wherein the relatively rigid mould section is a female mould section having a female mould cavity and the elastically deformable mould section is a male mould section having a male mould face.

45. A production system according to claim 44, wherein the resin supply means is provided by at least one resin supply line in fluid communication with the mould chamber.

46. A production system according to claim 45, wherein the resin supply line communicates with an opening in the male mould face or female mould cavity or enters an opening provided between the outer periphery of the female and male mould sections.

47. A production system according to claim 44, further including at least one vacuum line in fluid communication with the mould chamber, and sealing means provided between the female and male mould sections for providing an at least substantially air tight seal for the mould chamber.

48. A production system according to claim 47, wherein the vacuum line communicates with an opening in the male mould face or the female mould cavity or enters an opening provided between the outer periphery of the female and male mould sections.

49. A production system according to claim 44, wherein the male mould section is at least substantially made from rubber or other elastically deformable material.

50. A production system according to claim 44, wherein the male mould section is made of a material and or alternatively has a surface of the male mould face that readily separates from the composite component when fully cured.

51. A production system for producing a composite component including:
a mould assembly including:
a relatively rigid female mould section having a female mould cavity;
a peripheral portion surrounding the periphery of the female mould cavity, the ring portion including a ring chamber within which a resin can be supplied, resin supply means for supplying resin to the mould assembly;
a male mould section formed of an elastically deformable material, the male mould section having an outer male mould face;
the female mould section being supported on a first housing to form a first pressure chamber, and the male mould section being supported on a second housing to form a second pressure chamber;
a mould chamber being defined between the female mould cavity and the male mould face when the female and male mould sections are brought together;
fluid pressure means for applying a balanced fluid pressure due to a density and/or pressure of the fluid on opposing sides of the mould assembly; and
a vacuum supply means for producing a vacuum in the mould assembly.

52. A production system according to claim 51, wherein the ring chamber is defined by a peripheral relatively rigid ring flange surrounding and supporting the male mould section, the ring flange engaging the peripheral portion surrounding the female mould cavity.

53. A production system according to claim 52, further including a seal means, for example a resilient sealing rib(s), provided between the ring flange and the ring portion to provide an at least substantially air tight seal for the ring chamber.

54. A production system according to claim 51, wherein a series of resin lines supply resin to the ring chamber at points distributed along the chamber.

55. A production system according to claim 51, wherein a single resin supply line extends parallel with the ring chamber, the supply line having a series of bleed lines spaced therealong from which resin can be discharged into the ring chamber.

56. A production system according to claim 51, wherein the vacuum supply lines includes a vacuum pump and at least one vacuum line.

57. A production system according to claim 56, wherein a first said vacuum line is in communication with the mould chamber, and a second said vacuum line is in communication with the ring chamber, with a valve controlling the vacuum applied by both first and second vacuum lines.

58. A production system according to claim 57, further including a pressurised gas supply for supplying a pulse of high pressure gas periodically into the ring chamber.

59. A production system according to claim 51, further including lower and upper resin sensors provided within the ring chamber for respectively determining when the level of resin reaches a low point where further resin needs to be supplied, and a high point where no further resin needs to be supplied.

60. A production system according to claim 51, further including vibration means for vibrating the mould assembly.

61. A production system according to claim 51, including fluid circulation means for circulating fluid at an elevated temperature though each pressure chamber.

62. A production system according to claim 56, wherein the fluid circulation means further circulates fluid at elevated temperature or at a relatively lower temperature.

63. A production system according to claim 43, wherein the elastically deformable mould section has an outer surface, and a series of channels provided within the outer surface.

64. A production system according to claim 63 wherein the channels are provided in a mesh pattern across at least a substantial portion of the outer surface.

65. A production system according to claim 63 wherein the channels flatten when a sufficiently high fluid is applied to the elastically deformable mould section.

66. A method of producing a composite component using a production system according to claim 51, the resin supply means supplying resin to the ring chamber, the vacuum supply means being connected to the mould chamber, the method including filling the ring chamber with resin for supplying resin to the mould chamber, and providing a vacuum seal for the mould chamber while filled with resin.

67. A method of producing a composite component using a production system according to claim 51, the resin supply means being connected to the mould chamber, the vacuum supply means being connected to the ring chamber, the method including supplying resin to the mould chamber while a vacuum is applied to the ring chamber such that excess resin can overflow into the ring chamber.
